(19) United States
(12) Patent Application Publication
(10) Pub. No.: US 2007/0109336 A1
(43) Pub. Date: May 17, 2007

(54) Method for reducing an amount of ink used in printing an image

(75) Inventor: Du-Yong Ng, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/271,683

(22) Filed: Nov. 11, 2005

(51) Int. Cl. B41J 2/205

(52) U.S. Cl. 347/15

(57) ABSTRACT

A method for reducing an amount of ink used in printing an image includes processing data representing the image to distinguish each halftone region from each solid region, wherein each solid region is formed by boundary ON pixels connected to interconnected interior ON pixels and having a sum of a quantity of the boundary ON pixels and a quantity of the interior ON pixels satisfying a predetermined threshold quantity; performing halftoning on the interior ON pixels of each solid region to form a reduced number of interior ON pixels to achieve a desired gray scale level; and printing the image consistent with the halftone region(s), and consistent with the boundary ON pixels and the reduced number of interior ON pixels representing each solid region.

### BACKGROUND OF THE INVENTION

1. Field of the Invention

The present invention relates to printing, and, more particularly, to a method for reducing an amount of ink used in printing an image.

2. Description of the Related Art

An ink jet printer controls the operation of an ink jet printhead having a plurality of ink-ejecting nozzles for selectively placing ink dots on a print medium, such as paper, to form an image on the print medium. Dot gain is a phenomenon where the size of printed dots gets larger or smaller than the intended size, due to the spread of ink of the printed dots on the print media, such as a sheet of paper. If the dot gain is positive, the size of the printed dots is larger and the ink covers the printed region more quickly. The printed region can be completely covered by the ink even when it is not supposed to be. Also, more ink may be used to print the region than is necessary to completely cover the region.

### SUMMARY OF THE INVENTION

The invention, in one exemplary embodiment, is directed to a method for reducing an amount of ink used in printing an image. The image initially is represented by a plurality of ON pixels and a plurality of OFF pixels arranged as a plurality of regions including at least one halftone region and at least one solid region, wherein the ON pixels represent dot locations where ink dots are intended to be placed on a print medium. The method includes processing data representing the image to distinguish each of at least one halftone region from each of at least one solid region, wherein each solid region is formed by boundary ON pixels connected to interconnected interior ON pixels and having a sum of a quantity of the boundary ON pixels and a quantity of the interior ON pixels satisfying a predetermined threshold quantity; performing halftoning on the interior ON pixels of each solid region to form a reduced number of interior ON pixels to achieve a desired gray scale level; and printing the image consistent with the at least one halftone region, and consistent with the boundary ON pixels and the reduced number of interior ON pixels representing each solid region.

The invention, in another exemplary embodiment, is directed to a method for reducing an amount of ink used in printing an image formed by a plurality of ON pixels and a plurality of OFF pixels arranged as a plurality of halftone regions and a plurality of solid regions. The method includes processing data representing the image to distinguish the plurality of halftone regions from the plurality of solid regions, wherein each solid region is formed by boundary ON pixels connected to interconnected interior ON pixels and having a sum of a quantity of the boundary ON pixels and a quantity of the interior ON pixels satisfying a predetermined threshold quantity; performing halftoning on the interior ON pixels of each of the plurality of solid regions to form a reduced number of interior ON pixels to achieve a desired gray scale level; and printing the image consistent with the plurality of halftone regions and consistent with the boundary ON pixels and the reduced number of interior ON pixels representing the plurality of solid regions.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic depiction of a system embodying the present invention.

FIG. 2 is a graphical depiction of a pixel grid representing an initial image L FIG. 3 is a flowchart of an exemplary method of an embodiment of the present invention.

FIG. 4 is an exemplary depiction of image I after halftoning on the interior ON pixels, to form a modified image IM.

FIG. 5 is a graphical depiction of two maps, EMap and CMap, that have the same dimension as the input image, and two stacks, TempStack and IStack.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

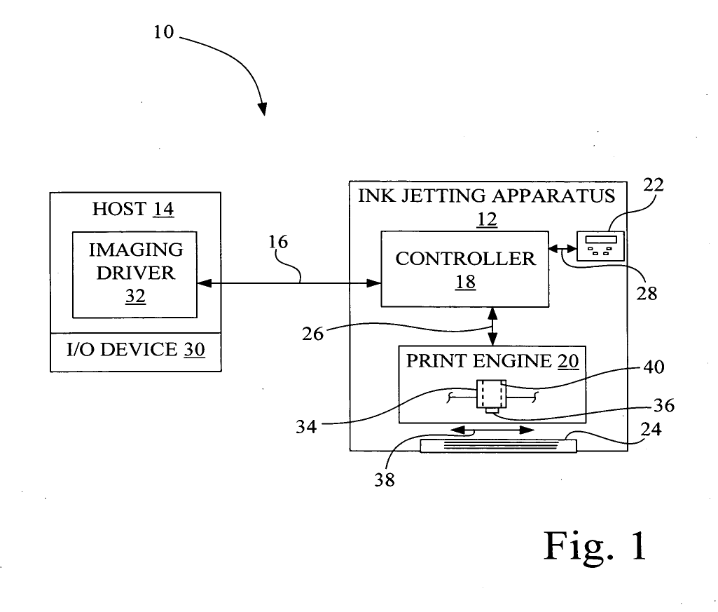

Referring to FIG. 1, there is shown a diagrammatic depiction of an imaging system 10 embodying the present invention. Imaging system 10 may include an ink jetting apparatus 12 and a host 14. Ink jetting apparatus 12 communicates with host 14 via a communications link 16.

As used herein, the term “communications link” is used to generally refer to structure that facilitates electronic communication between multiple components, and may operate using wired or wireless technology. Accordingly, for example, communications link 16 may be established by a direct cable connection, wireless connection or by a network connection such as for example an Ethernet local area network (LAN).

Alternatively, ink jetting apparatus 12 may be a standalone unit that is not communicatively linked to a host, such as host 14. For example, ink jetting apparatus 12 may take the form of a multifunction machine that includes standalone copying and facsimile capabilities, in addition to optionally serving as a printer when attached to a host, such as host 14.

Ink jetting apparatus 12 may be, for example, an ink jet printer and/or copier. Ink jetting apparatus 12 includes, for example, a controller 18, a print engine 20 and a user interface 22. In the context of the examples for ink jetting apparatus 12 given above, print engine 20 may be, for example, an ink jet print engine configured for forming an image on a sheet of print media 24, such as a sheet of paper, transparency or fabric.

Controller 18 includes a processor unit and associated memory, and may be formed as an Application Specific Integrated Circuit (ASIC). Controller 18 communicates with print engine 20 via a communications link 26. Controller 18 communicates with user interface 22 via a communications link 28. Communications links 26 and 28 may be established, for example, by using standard electrical cabling or bus structures, or by wireless connection.

Host 14 may be, for example, a personal computer including an input/output (I/O) device 30, such as keyboard and display monitor. Host 14 further includes a processor, input/output (I/O) interfaces, memory, such as RAM, ROM, NVRAM, and a mass data storage device, such as a hard drive, CD-ROM and/or DVD units. During operation, host 14 includes in its memory a software program including program instructions that function as an imaging driver 32, e.g., printer driver software, for ink jetting apparatus 12. Imaging driver 32 is in communication with controller 18 of ink jetting apparatus 12 via communications link 16. Imaging driver 32 facilitates communication between ink jetting apparatus 12 and host 14, and may provide formatted print data to ink jetting apparatus 12, and more particularly, to print engine 20.

Alternatively, however, all or a portion of imaging driver 32 may be located in controller 18 of ink jetting apparatus 12. For example, where ink jetting apparatus 12 is a multifunction machine having standalone capabilities, controller 18 of ink jetting apparatus 12 may include an imaging driver configured to support a copying function, and/or a fax-print function, and may be further configured to support a printer function. In this embodiment, the imaging driver facilitates communication of formatted print data, as determined by a selected print mode, to print engine 20.

Print engine 20 may include, for example, a reciprocating printhead carrier 34 that carries at least one ink jet printhead 36. Under the control of controller 18, printhead carrier 34 transports ink jet printhead 36 in a reciprocating manner in a bi-directional main scan direction 38 over an image surface of sheet of print media 24 during printing operations. Printhead carrier 34 may be mechanically and electrically configured to mount, carry and facilitate one or more printhead cartridges 40, such as a monochrome printhead cartridge and/or one or more color printhead cartridges. Each printhead cartridge 40 may include, for example, an ink reservoir containing a supply of ink, to which at least one respective ink jet printhead 36 is attached.

In order for print data from host 14 to be properly printed by print engine 20, the data generated by host 14 that represents an image is converted into image data compatible with print engine 20 and ink jet printhead 36. The image data may be, for example, initially represented by data in the form of a plurality of ON pixels and a plurality of OFF pixels arranged as a plurality of regions including one or more halftone regions and one or more solid regions, wherein the ON pixels represent dot locations where ink dots are intended to be placed on a print medium, e.g., the sheet of print media 24, and the OFF pixels represent dot locations where ink dots are not intended to be placed on a print medium. The example may be applied to a monochromatic image, e.g., a black and white image, or to each color plane of a color image.

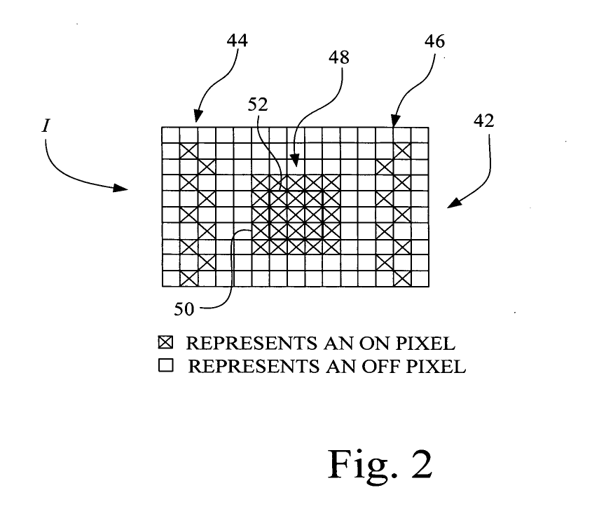

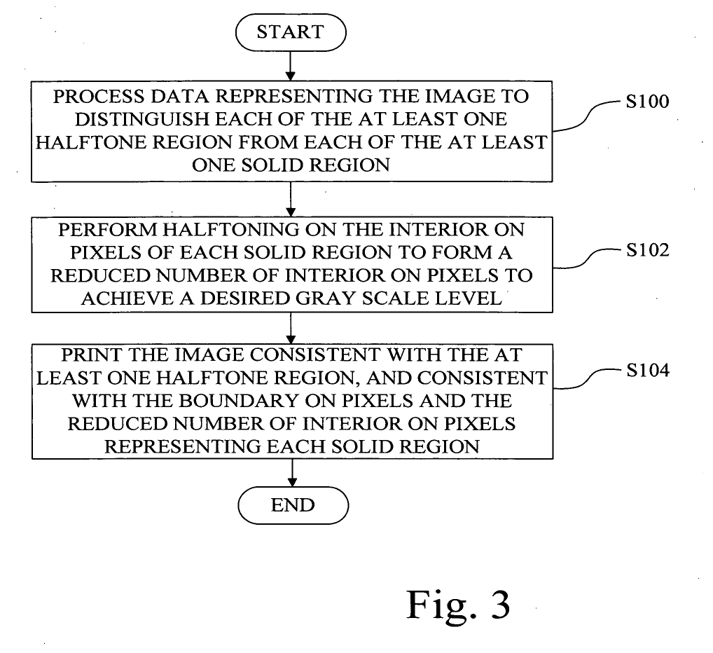

FIG. 2 is a graphical depiction of a simplified example showing a pixel grid 42 representing an initial image I by a plurality of ON pixels (each represented by an X) and a plurality of OFF pixels (each represented by an open box). In the example of FIG. 2, the plurality of ON pixels and the plurality of OFF pixels are arranged as a plurality of regions, including a halftone region 44, a halftone region 46 and a solid region 48.

In accordance with an exemplary method of an embodiment of the present invention, represented by the flowchart of FIG. 3, the usage of ink in printing solid content, e.g., solid region 48, of the image data may be reduced, while preserving the halftone content, e.g., halftone regions 44, 46, and the overall print quality of the image.

At step S100, data representing the image, e.g., initial image 1, is processed, e.g., by host 14 and/or controller 18, to distinguish each (e.g., at least one) halftone region from each (e.g., at least one) solid region. Referring to FIG. 2, each solid region is formed by boundary ON pixels connected to interconnected interior ON pixels and having a sum of a quantity of the boundary ON pixels and a quantity of the interior ON pixels satisfying a predetermined threshold quantity. In the example of FIG. 2, solid region 48 includes sixteen (16) interconnected boundary ON pixels 50 and nine (9) interconnected interior ON pixels 52. If, for example, the threshold is twelve (12) ON pixels, then solid region 48 will be identified as having solid content. Step S100 will be described in more detail later.

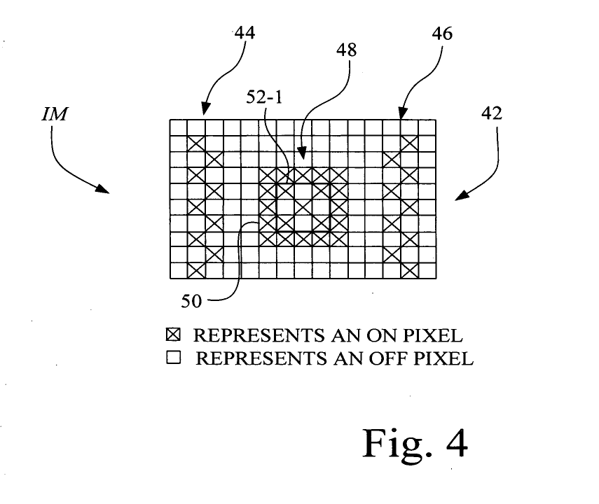

At step S102, halftoning on the interior ON pixels of each solid region is performed to form a reduced number of interior ON pixels to achieve a desired gray scale level. Referring to the example of FIG. 4, if, for example, the desired gray scale level is 50 percent coverage, then the number of interior ON pixels 52 of the initial image shown in FIG. 2 may be reduced by the halftone algorithm from nine (9) interconnected interior ON pixels 52 to a halftone area with a reduced number of interior ON pixels 52-1, e.g., five (5) interior ON pixels 52-1, as represented by modified image IM.

At step S104, the image is printed consistent with the at least one halftone region, and consistent with the boundary ON pixels and the reduced number of interior ON pixels representing each solid region. For example; and referring to FIG. 4, the image IM is printed on the sheet of print media 24, consistent with each halftone region, e.g., half tone regions 44 and 46, and consistent with the boundary ON pixels 50 and the reduced number of interior ON pixels 52-1 representing each solid region, e.g., solid region 48.

Each of the method steps S100 and S102 set forth above will now be explained in more detail with respect to a detailed example.

In step S100, the data representing the image, e.g., initial image I, is processed to distinguish halftone regions, e.g., halftone regions 44 and 46 of FIG. 2, from solid regions, e.g., solid region 48, of the image data, with each solid region being formed by boundary ON pixels connected to interconnected interior ON pixels. Accordingly, the solid content is segregated from the halftone content. In a typical black and white halftone image, for example, there is a distinct difference between the solid content and the halftone content, since the solid content has a significantly larger number of connected black pixels compared to that of the halftone content. In addition, a halftone region often contains many small isolated groups of black or white pixels. The exemplary algorithm set forth below capitalizes on these differences to single out the solid content and segment the interior region of the solid region.

This algorithm will first search for an ON pixel, e.g., a black pixel, in the input image in raster order. When an ON pixel p is found, other ON pixels in its neighborhood are located. A neighbor is defined to be a pixel location that is vertically or horizontally adjacent to pixel p, and not diagonal to pixel p. Thus, a pixel neighborhood for each pixel p will include four additional pixel neighbors. For each of these neighbors, the algorithm will search repeatedly for their corresponding neighbors that have not been searched. If an ON pixel has an ON pixel neighbor in every part of the neighborhood, then the pixel is considered to be an interior pixel. The spatial location of every interior pixel will be tracked since these pixels could be of interest. When all the pixels connected to pixel p are located, if total number of these ON pixels is greater than a threshold T and the region does not contain any small isolated groups of OFF pixels, then, these ON pixels are designated as pixels of a solid ON region. The spatial location of the set of interior pixels connected to pixel p will be saved in this case. The search for other solid regions in the image is continued until the whole image is completely searched. The details of the algorithm operation are given as follows:

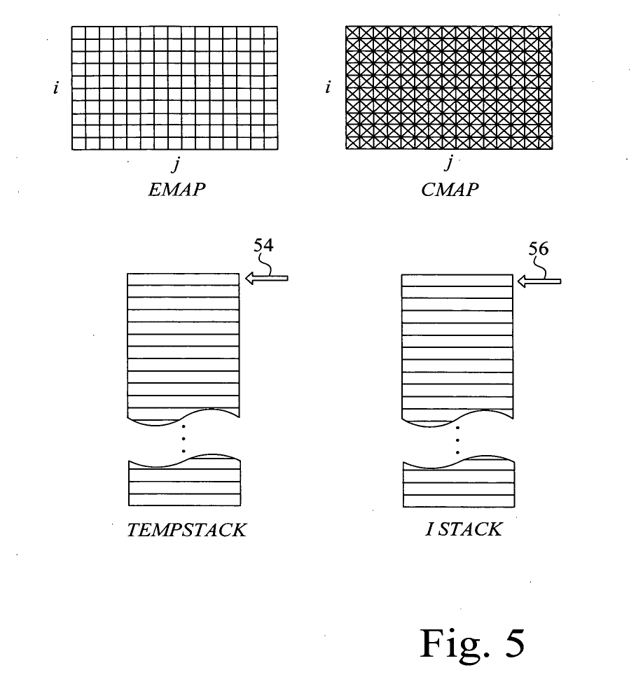

Two maps (which will be referred to as EMap and CMap) are allocated that have the same dimension as the input image I (see, e.g., FIG. 2), and two stacks (which will be referred to as TempStack and IStack) are allocated. EMap, CMap, TempStack, and IStack are graphically depicted in FIG. 5, and may be established in memory of host 14, or memory of ink jetting apparatus 12. The stack pointer 54 to the stack, TempStack, will be referenced by the variable,

stackPointer-to-TempStack. The stack pointer 56 to the stack, IStack, will be referenced by the variable, stackPointer-to-IStack . The number of edge pixels will be referenced by the variable, NumberOfEdgePixels.

a) Initialize: EMap=0 and CMap=1 for all pixels; in FIG. 5 an ON pixel is represented by X and is a “1”, and an OFF pixel is an open box and is an “0”.
b) Initially, Set:stackpointer-to-TempStack=0, NumberOfEdgePixels=0, stackPointer-to-IStack=0, and Isolated_white=0.
c) Search the input image, I, for an ON pixel in raster order. Set CMap=0 for every pixel that has been visited.
d) If an ON pixel at a point(i,j) is encountered and CMap(i,j)==1, set CMap(i,j)=0 and find the 4-point neighbors of I(i,j).
e) If I(i, j)has an ON neighbor at the point(i′, j′) and CMap(i′, j′)=1 for this neighbor, set CMap(i′, j′)=0 for this neighbor, push the point (i′, j′) to TempStack, increment the stackPointer-to-TempStack by 1.
f) If I(i,j) has an OFF neighbor at the point (i′,j′), center a window of size W X W at (i′,j′). If the OFF neighbor at the point (i′,j′) and its connected neighbors are surrounded by ON pixels in this window, increment Isolated_white by 1.
g) Repeat step (e) for every ON neighbor of I(i, j).
h) If I(i, j) has 4 ON neighbors, then it is an interior pixel. Push the point (i, j) to IStack and increment stackpointer-to-IStack by 1. Otherwise, I(i,j) is an edge pixel. Then, increment NumberOfEdgePixels by 1.
i) Pop a point, (i*, j*), from the TempStack and decrement stackPointer-to-TempStack by 1.
j) Repeat step (e) through step (i) for (i*,j*)
k) While stackPointer-to-TempStack>0, repeat step (i) and step (j).
l) All the pixels in IStack and the edge pixels are said to be connected.
   i. If stackPointer-to-IStack+NumberOfEdgePixels>T (a predefined threshold) and Isolated_white=0, then these connected pixels belong to a solid region, i.e., are solid content. Pop every point from IStack and label these points in EMap with an integer m. The threshold T can be determined experimentally for a given halftoning scheme that has already been applied to the input image.
   ii. Otherwise, ignore these connected pixels and repeat step (b) and step (d) through step (1) for every I(i, j) with CMap(i, j)==1.

Next, with respect to step S102, the interior of each solid region is halftoned. The EMap obtained earlier contains all the spatial information about the interior of the solid region in the image. It may be used together with any halftoning algorithm to select, i.e., change, the average gray level in the corresponding region of the input image. One such halftoning algorithm is the Floyd-Steinberg error diffusion halftoning algorithm, which is implemented as follows:
a) Determine an average gray level, G, to replace the interior region of the solid content of the input image.
b) If G==0, nothing needs to be done. This is the same as the input image I.
c) If G==255, at every point (i, j) where EMap(i, j)==m, set I(i, j)=white, wherein the constant, white, represents an OFF pixel.
d) If 0<G<255, allocate a 2D pixel buffer, buf and initialize every pixel as follows:

$$buf ( i , j ) - \{ \begin{matrix}G & if & EMap ( i , j ) == m \\ & 0 , & otherwise\end{matrix}$$

where (i, j) is the spatial coordinates of a pixel in the buffer.
e) At every point (i, j):
a. Compute the quantization error, QError:

$$QError = \{ \begin{matrix}buf ( i , j ) - 255 & if & buf ( i , j ) > 127 \\ buf ( i , j ) , & & otherwise\end{matrix}$$
b. Diffuse QError to ‘future’ pixels:

$$buf ( i , j + 1 ) = buf ( i , j + 1 ) + \frac{7}{16} \cdot QError ;$$

$$buf ( i + 1 , j - 1 ) = buf ( i + 1 , j - 1 ) + \frac{3}{16} \cdot QError ;$$

$$buf ( i + 1 , j ) = buf ( i + 1 , j ) + \frac{5}{16} \cdot QError ;$$

$$buf ( i + 1 , j + 1 ) = buf ( i + 1 , j + 1 ) + \frac{1}{16} . QError ;$$
c. Replace the interior of the solid region in the input image I:
   Set I(i, j)=white if EMap(i, j)==m and buf (i, j)>127

The minimum value of the average gray level G for which the interior of a solid region is printed completely can be determined by experiment. To save ink during printing, the initial solid region of the input image I may be halftoned to have an average value of the average gray level G before the input image is sent to the print engine. The value of the average gray level G can also be varied between 0 and 255 to replace the solid black region with different shades of gray in the printed document. Since only the solid regions of the input image are modified, this method does not affect the halftone content regions of the image. Thus, the interior portion of the solid region(s) may be replaced by a variable gray shade while keeping the edges of the content intact for artistic purposes.

While this invention has been described with respect to embodiments of the invention, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for reducing an amount of ink used in printing an image, said image initially being represented by a plurality of ON pixels and a plurality of OFF pixels arranged as a plurality of regions including at least one halftone region and at least one solid region, said ON pixels representing dot locations where ink dots are intended to be placed on a print medium, comprising:
processing data representing said image to distinguish each of said at least one halftone region from each of said at least one solid region, wherein each solid region is formed by boundary ON pixels connected to interconnected interior ON pixels and having a sum of a quantity of said boundary ON pixels and a quantity of said interior ON pixels satisfying a predetermined threshold quantity;
performing halftoning on said interior ON pixels of each solid region to form a reduced number of interior ON pixels to achieve a desired gray scale level; and
printing said image consistent with said at least one halftone region, and consistent with said boundary ON pixels and said reduced number of interior ON pixels representing each solid region.

2. The method of claim 1, wherein said desired gray scale level is selected from a plurality of possible gray scale levels.

3. The method of claim 1, wherein said threshold is determined experimentally for a given halftoning scheme.

4. The method of claim 1, wherein the act of printing is performed without modifying said at least one halftone region and without modifying said boundary ON pixels of said at least one solid region.

5. The method of claim 1, wherein a minimum value of an average gray level corresponding to said desired gray scale level is determined by experiment.

6. The method of claim 5, wherein said average gray level is varied to replace said at least one solid region with different shades of gray in a printed document representing said image.

7. The method of claim 1, wherein each solid region has said sum that satisfies said predetermined threshold quantity, and there is no small isolated groups of OFF pixels.

8. A method for reducing an amount of ink used in printing an image formed by a plurality of ON pixels and a plurality of OFF pixels arranged as a plurality of halftone regions and a plurality of solid regions, comprising:
processing data representing said image to distinguish said plurality of halftone regions from said plurality of solid regions, wherein each solid region is formed by boundary ON pixels connected to interconnected interior ON pixels and having a sum of a quantity of said boundary ON pixels and a quantity of said interior ON pixels satisfying a predetermined threshold quantity;
performing halftoning on said interior ON pixels of each of said plurality of solid regions to form a reduced number of interior ON pixels to achieve a desired gray scale level; and
printing said image consistent with said plurality of halftone regions and consistent with said boundary ON pixels and said reduced number of interior ON pixels representing said plurality of solid regions.

9. The method of claim 8, wherein said desired gray scale level is selected from a plurality of possible gray scale levels.

10. The method of claim 8, wherein said threshold is determined experimentally for a given halftoning scheme.

11. The method of claim 8, wherein the act of printing is performed without modifying said plurality of halftone regions and without modifying said boundary ON pixels of said plurality of solid regions.

12. The method of claim 8, wherein a minimum value of an average gray level corresponding to said desired gray scale level is determined by experiment.

13. The method of claim 12, wherein said average gray level is varied to replace at least some of solid regions of said plurality of solid regions with different shades of gray in a printed document representing said image.

14. The method of claim 8, wherein each solid region has said sum that satisfies said predetermined threshold quantity, and there is no small isolated groups of OFF pixels.
